(19) United States
(12) Patent Application Publication
(10) Pub. No.: US 2005/0197976 A1
(43) Pub. Date: Sep. 8, 2005

(54) System and method for processing toll transactions

(76) Inventors: James D. Tuton, Scottsdale, AZ (US); Phillip S. Mestnick, Scottsdale, AZ (US); Michael G. Arnold, Scottsdale, AZ (US); Diana E. Phillips, Scottsdale, AZ (US); Adam E. Tuton, Paradise Valley, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/889,746

(22) Filed: Jul. 12, 2004

Related U.S. Application Data
(60) Provisional application No. 60/549,578, filed on Mar. 3, 2004.

(51) Int. Cl. G07B 13/04

(52) U.S. Cl. 705/417

(57) ABSTRACT

A system and method for fleet-based processing of toll transactions comprises: a toll processing service provider (140); toll agencies (160) providing toll transaction data (152, 154) to the toll processing service provider (140); fleet vehicle owners (120) providing fleet vehicle information (132) to the toll processing service provider (140), whereby a match between the toll transaction data (152, 154) provided by toll authorities (160) and the vehicle information (132) provided by fleet vehicle owners (120) results in payment(s) (158) made to the toll agencies (160) by the toll processing service provider (140) on behalf of the fleet vehicle owners (120). Disclosed features and specifications may be variously controlled, adapted or otherwise optionally modified to improve fleet-based collection of tolls for any application or operating environment. Exemplary embodiments of the present invention generally provide for the elimination or reduction of toll violation processing.

### RELATED APPLICATION

Applicants claim priority to U.S. Provisional Patent Application Ser. No. 60/549,578 filed on Mar. 3, 2004, the disclosure of which is hereby incorporated by reference.

### FIELD OF INVENTION

The present invention generally involves automation of traffic monitoring, toll payment and violation processing systems. More particularly, representative embodiments of the present invention generally include systems for the recording, storage and processing of graphical and textual data to enable automated collection of toll payments from fleet vehicle owners and individual subscribers.

Automated traffic monitoring systems have been used for a number of years to identify vehicles and/or operators violating various traffic regulations. Some of these traffic monitoring systems include cameras configured to capture a photographic image of vehicles that violate the traffic laws or regulations. Sometimes, the traffic monitoring systems are deployed in mobile vehicles. In other cases, the systems may be stationary; positioned close to the roadway, for example, at ground level or elevated on a pole or other structure. These systems may be manually controlled or they may be operated automatically or remotely, without an operator present.

Automated traffic monitoring and enforcement systems have been used in the United States for some time. Such systems have been employed by government agencies to reduce traffic accidents and by toll authorities to reduce the number of toll cheats and to generate additional revenues, inasmuch as the income from their operation exceeds the cost of installing and maintaining the equipment. However, the use of existing automated violation enforcement systems has generally not found application for the automated collection of tolls, fees and fines from Fleet and Rental Vehicle Owners (FVO) and their customers.

Conventional methods for processing fleet or rental vehicle toll violations typically include a series of processes to review violation images captured from the road way and the delivery of a toll violation notice to the registered owner of the vehicle (e.g., the Fleet Vehicle Owner). The FVO may pay the toll amount and associated fine directly to the toll authority (TA) and then pass the charges on to the vehicle renter or lessee. However, a number of potential problems are associated with this approach.

For example, conventional toll processing methods do not generally enable an efficient means to identify and directly invoice vehicle renters and/or lessees. This creates a series of complex, time consuming and costly additional processes. Violation notices and/or invoices are typically sent by the TA to the FVO, requiring the subsequent determination of who rented or leased the vehicle at the time of the violation. The TA then is typically required to forward the name and address of the driver back to the TA. The TA, in turn, may then issue a second notice to the renter or lessee, who was identified by the FVO. However, TA business rules typically aggregate violations and send notices to registered owners after n violations have accumulated in y period. Problems may arise when the toll violation notice includes more than one violation and one or more violations were caused by different renters or lessees. Moreover, if the second notice is returned as undeliverable, then the TA may issue a third notice back to the FVO, or otherwise contact the FVO to make them aware of the inability to contact the identified renter or lessee.

Conventional approaches for the collection of tolls from fleet vehicle operators generally involve complex and expensive business processes for both the FVO and the TA. Accordingly, what is needed is a toll collection system that eliminates, automates or otherwise reduces the processing steps associated with vehicle toll violations or license plate-based toll collection, while ensuring that the TA will collect the tolls that are due.

### SUMMARY OF THE INVENTION

In various representative aspects, the present invention provides a system and method for automated collection of tolls and fees based on unique (e.g., license plate) information, which identifies vehicles owned by FVO's or individual subscribers. This unique information may be used, for example, to either identify the renter/lessee, or to automatically post a debit transaction to an account. Exemplary features provide for: the elimination or reduction of complex and expensive violation processing costs for TA's and/or rental car operators; the enablement of vehicle renters and/or lessees to use high-speed, electronic toll collection systems using only their license plate as a means of identification for toll payment; the automation of the exchange of renter/lessee information and processing of rental and fleet vehicle toll violations; and the ability to issue violation notices to specific vehicle renters, rather than to FVOs.

Additional advantages of the present invention will be set forth in the Detailed Description which follows and may be apparent from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter a/ia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the detailed description, wherein:

FIG. 1 representatively illustrates a block diagram of a license plate-based fleet toll collection system in accordance with an exemplary embodiment of the present invention;

FIG. 2 representatively illustrates a process schematic for fleet vehicle enrollment in accordance with an exemplary embodiment of the present invention; and

FIG. 3 representatively illustrates a process schematic workflow for license plate-based toll collection for fleet and personal accounts in accordance with an exemplary embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other configurations and/or orientations than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for eliminating or otherwise reducing the need for toll/fee/fine violation processing in addition to reducing the steps otherwise required to process violations Certain representative implementations may include, for example: establishment of individual or master accounts associated with unique (e.g., license plate) numbers—which may be used to debit the amount for tolls due from enrolled vehicles that pass collection points on toll roads; charge service or convenience fees for use of the unique (e.g., license plate) identification system; and to automate the identification of a specific user or renter of a vehicle for issuance of violation notices and/or collection of fines.

As used herein, the terms “toll”, “fee”, and “fine”, or any variation or combination thereof, are generally intended to include anything that may be regarded as at least being susceptible to characterization as, or generally referring to, a monetary sum customarily charged to operate (or to provide a disincentive to operate) or otherwise dispose a vehicle for subsequent use or storage. The same shall properly be regarded as within the scope and ambit of the present invention. Additionally, the use of the word “fleet” should not be restricted to mean or otherwise reference a large plurality of vehicles. A single operator may operate or otherwise maintain a fleet comprising a single vehicle. Additionally, the use of the word “violation” and/or any variation thereof, shall also be understood to include exceptions and/or any other type of triggering event, whether now known, hereafter employed or otherwise described in the art.

A detailed description of an exemplary application, namely the elimination, or otherwise reduction, of violation processing for fleet-based collection of road-use tolls, is provided as a specific enabling disclosure that may be generalized by skilled artisans to any application of the disclosed system and method for toll/fee/fine collection in accordance with various embodiments of the present invention. For example, various other embodiments of the present invention may be applied to realize the fleet-based collection of parking fees or traffic violation fines.

Moreover, skilled artisans will appreciate that the principles of the present invention may be employed to ascertain and/or realize any number of other benefits associated with fleet-based toll collections such as, but not limited to: the elimination or reduction of complex and expensive violation processing costs for FVOs and/or rental car operators; the ability of FVOs and/or rental car agencies to offer their customers the option of manual or electronic toll payment methods without the use of, for example, traditional transponders; the generation of substantial new revenues for toll agencies, FVOs and/or rental car companies; the enablement of vehicle renters to use high-speed electronic toll collection systems; the automation of the exchange of information and processing for rental and fleet vehicle identification; the ability to issue violation notices to specific vehicle renters, rather than to FVOs; and/or the like.

In a representative application, in accordance with an exemplary embodiment of the present invention, a ‘license plate’-based vehicle identification and toll payment system is disclosed for enabling enrollment of rental car fleet vehicles for fleet-based payment of tolls with the virtual elimination, or otherwise substantial reduction, of violation processing procedures for both subscribing FVOs and toll authorities. Various embodiments of the disclosed system and method allow toll agencies to automatically collect tolls due from fleet and rental vehicles that use the toll roads without the need for additional on-board hardware, toll tags and/or transponders. However, various other embodiments may optionally employ tags and/or transponders as a data capture mechanism. Accordingly, the present invention should not be limited to the embodiments recited herein as based on photographic capture of license plate or other fleet identification or markings on fleet vehicles.

Subscribing individuals, rental car agencies and fleet operators can enroll their vehicles with a toll processing service provider (TPSP) to enable their vehicle fleet by providing the TPSP with, for example, current license plate numbers and corresponding vehicle information for each of their active rental or fleet vehicles. The TPSP typically manages a secure master plate table which may be accessed by the toll authority (TA) computer system via, for example, secure electronic interface.

The TA or TPSP generally evaluates images captured in the toll lanes, identifies the license plate numbers and the TPSP pays the subscribing TA all toll revenue due for any vehicle with a license plate enrolled in the master plate table. Accordingly, the TPSP becomes responsible for payment of the tolls to the respective TA on behalf of the FVO, and the TPSP generally settles with the FVO in a separate transaction.

In various exemplary embodiments of the present invention, the TPSP is responsible for payment of tolls for all of the FVO's enrolled vehicles on any/all subscribing TA toll roads. Enrolled fleet vehicles may be equipped with a conventional toll tag/transponder, or alternatively in certain representative preferred embodiments, the FVO account may be associated with, for example, vehicle license plate information or other alphanumeric or coded identification displayed on or transmitted by the fleet vehicle.

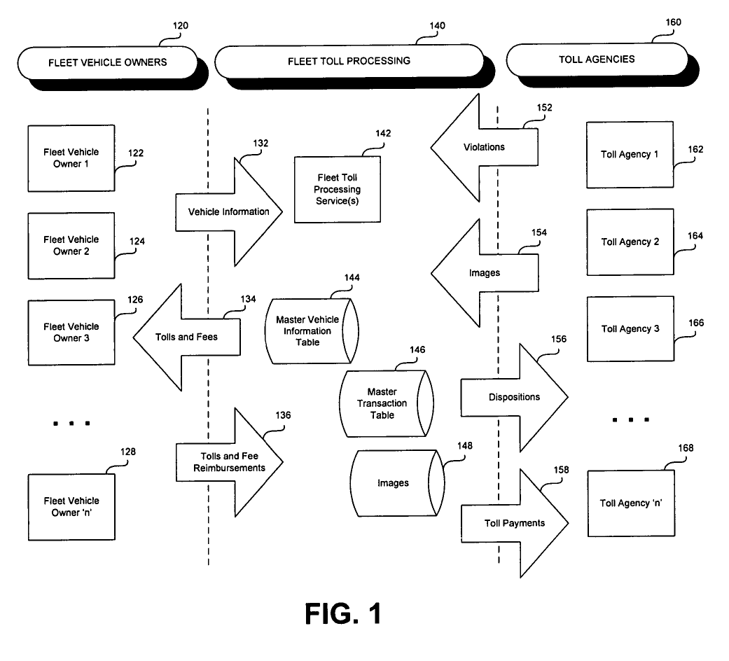

In representative applications, in accordance with various exemplary embodiments of the present invention, the TPSP may be suitably configured, or otherwise adapted, to offer the disclosed fleet-based toll collection system as a service-level offering, as shown, for example in FIG. 1. In an exemplary embodiment, the TPSP 140 may generally guarantee payment of tolls 158 to member TAs 160 for all enrolled fleet and rental vehicles which trigger, for example, images or camera-based violations or camera-based transactions.

In an exemplary embodiment, in accordance with the present invention, member TAs 160 may comprise a plurality of TAs 162, 164, 166, 168 (e.g., Harris County Toll Road Authority, North Texas Toll Road Authority, Florida Turnpike, etc.). Similarly, FVOs 120 may comprise a plurality of FVOs 122, 124, 126, 128 (e.g., Hertz, Avis, National, Budget, Alamo, Dollar, Enterprise, individuals, etc.)

TPSP 140 will typically maintain a master vehicle information table 144 populated with, for example, current FVO license plate data 132 from participating FVOs 120. As shown in FIG. 1, FVOs 120 may access the TPSP 140 toll processing service 142 and provide files (adds, changes, deactivates, etc.) of fleet license plate and vehicle information 132. In addition, TPSP 140 master vehicle information table 144 may also be populated by individual's establishing and pre-paying a toll account. TPSP 140 will generally permit TA 160 systems to access the TPSP 140 master plate table 144 via, for example, electronic interface for automated license plate lookup based on, for example, violation data 152 (e.g., textual data) and/or vehicle image capture data 154 (e.g., graphical data).

If a matching plate for the TA 160 supplied data 152, 154 is provided to the master plate table 144 (via, for example, an electronic interface) and once verified, TPSP 140 will return disposition data 156 for the TA 160 supplied data 152, 154 and will pay the toll amount and any agreed upon surcharge 158 directly to the TA 160; thus eliminating the need to issue toll violation notices for enrolled vehicles.

TPSP 140 thereafter generally bills the FVOs for the tolls and/or fees 134 due. Payment of the tolls and/or fees 134 by the FVOs may be reconciled 136 with TPSP 140 at a later time, concurrent with the transaction (e.g., in ‘real time’), or may be pre-paid by FVOs or the operators or renters of fleet vehicles themselves. The tolls and/or fees 134 billed to the FVOs and/or fleet vehicle operators may comprise, for example: a toll fee; a transaction fee; a processing fee; an enrollment fee; an overage fine; and/or any other fee, usage charge, fine or penalty charge now known or hereafter described in the art.

In order to provide verification of the validity of the toll transaction, TPSP 140 may also be configured, or otherwise adapted, to optionally provide a master transaction table 146 to record/archive processed toll transactions, exceptions and/or rejected toll processing requests. TPSP 140 may also be configured, or otherwise adapted, to optionally provide an image database 148 that may be correlated to data in the master transaction table 146 to provide an evidentiary basis for the validity of a particular toll transaction.

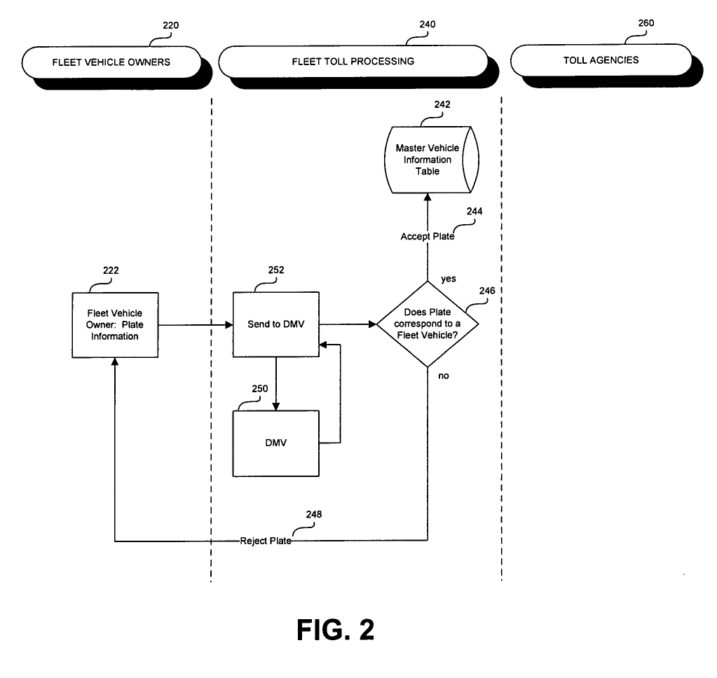

As representatively depicted in FIG. 2, for example, the master vehicle information (e.g., license plate) table 242 may be created and updated automatically via interface to FVOs 220 fleet license plate database 222. In the context of various representative embodiments of the present invention, the license plate data 222 may include, for example: the plate number; the state; the plate type; vehicle description (such as: make; model; year; color; style; etc.); vehicle identification number; and/or the like. The plate type may be null for those states that do not utilize a plate type.

In accordance with an exemplary embodiment of the present invention, the FVO 220 sends a file to TPSP 240, which contains inter alia license plate data and vehicle information 222 for their fleet vehicles that the FVO 220 wishes to enroll in master plate table 242 with an action of “Add.” The file layout of the plate transfer file between the FVO 220 and TPSP 240 may be generally defined with the following schema:

PLATE TRANSFER FILE LAYOUT

| Field | Description |
|---|---|
| Action | A = Add, C = Change, D = Deactivate, R = Reject |
| Effective Date | Date/Time of Addition, Change or Deactivate |
| Plate Number | Plate Number |
| Plate State | AZ, TX, FL, etc. |
| Plate Type | Plate Type (may be blank) |
| Fleet Company | Hertz, Avis, etc. |
| Make | Vehicle Make (Ford, Honda, etc.) |
| Model | Vehicle Model |
| Color | Vehicle Color |
| Style | Vehicle Style (2 dr, 4 dr, etc.) |
| VIN | Vehicle Identification Number |
| Year | Vehicle Year |

In representative and exemplary embodiments of the present invention, this schema may be generally used to pass vehicle information 132 from the FVO 120 to TPSP 140 with the actions of, for example: “Add”; “Change”; “Deactivate”; and/or the like. If the plate information cannot be validated 250 or otherwise determined to be registered to the FVO 220, the TPSP 240 may respond to the FVO 220 with an action of, for example, “Reject” 248. In general, TAs 260 do not participate, or are otherwise not necessarily required to participate, in the fleet vehicle enrollment process generally depicted, for example, in FIG. 2.

Continuing with the enrollment steps shown in FIG. 2, TPSP 240 optionally sends 252 the license plate data 222 to the appropriate Department of Motor Vehicles (DMV) 250 to lookup the registered owner of the vehicle (e.g., ownership information), which in an exemplary embodiment of the present invention would correspond to, for example, the FVO 220 seeking enrollment for the vehicle corresponding to license plate data 222. DMV 250 sends a file back to TPSP 240 (i.e., the returning arrow from element 250 to element 252 in FIG. 2) containing, for example, the name, address and vehicle information. TPSP 240 then performs a review 246 of each name and address returned by DMV 250 to ensure that the registered owner of the vehicle corresponding to license plate data 222 is indeed the FVO 220. This review 246 generally protects the accuracy of the data 222 provided by the FVO 220, and eliminates, or otherwise reduces, customer disputes and inaccurate invoicing. In representative and exemplary embodiments, in accordance with the present invention, the review 246 of data provided by DMV 250 and data 222 provided by FVO 220 may be either manual or automatic, or some combination thereof.

If the registered owner of the vehicle corresponding to license plate data 222 is not the FVO 220, then the entry is sent back to the FVO 220 via, for example, electronic interface with an action of “Reject”. Skilled artisans will appreciate that a third-party may be interleaved or otherwise charged with enrolling FVO 220 fleet vehicle information 132, and that such third-party may comprise, for example, a sub-division of the FVO 220, a sub-division of the TPSP 240, a sub-division of the TA 260, an entirely unique and separate entity, and/or any combination thereof.

If the registered owner of the vehicle corresponding to license plate data 222 is the FVO 220, a vehicle information data 132 entry is added 244 to the TPSP 240 master plate table 242. A representative and exemplary layout for the TPSP 240 master plate table may employ, for example, the following schema:

MASTER PLATE TABLE

| Field | Description |
|---|---|
| Plate Number | Plate Number |
| Plate State | AZ, TX, FL, etc. |
| Plate Type | Plate Type (may be blank) |
| Fleet Company | Hertz, Avis, etc. |
| Make | Vehicle Make (Ford, Honda, etc.) |
| Model | Vehicle Model |
| Color | Vehicle Color |
| Style | Vehicle Style (2 dr, 4 dr, etc.) |
| VIN | Vehicle Identification Number |
| Year | Vehicle Year |
| Effective Date | Date/Time of Addition or Update |
| Use-Start-Date | Date/Time of Start of Use. If null, then no constraints |
| | on the time of use |
| Use-Stop-Date | Date/Time of Start of Use. If null, then no constraints |
| | on the time of use |

In certain exemplary applications, in accordance with various representative embodiments of the present invention, the FVO 220 may have the opportunity to update the master plate table 242, for example, on a periodic/nightly basis with new vehicles (“Adds”), with changes to vehicle descriptions (“Changes”), and/or with plates that are no longer active (“Deactivates”). TPSP 240 may be configured, or otherwise suitably adapted, to continue to qualify additions and changed license plate data 222 and registered owner information through the DMV 250 lookup and review process 246 on, for example, a daily basis.

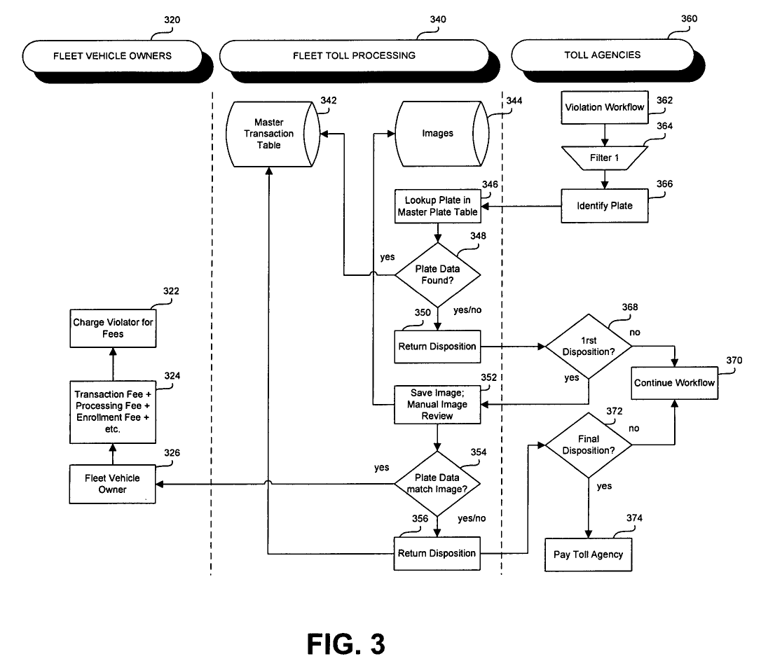

The identification and processing of a fleet-based toll transaction is representatively illustrated, for example, in the workflow diagram depicted in FIG. 3. After license plate data is captured by TA 360 (and optionally identified 366 and/or filtered 364 during pre-submission violation workflow 362), the violation transaction is passed to the TPSP 340 processing center. In a representative and exemplary embodiment, the violation information will be similar to that which is passed, for example, to the TA 360 patron account database for plate lookup. The layout of the violation transaction may be generally defined by the following schema:

VIOLATION TRANSACTION LAYOUT TABLE

| Field | Description |
|---|---|
| Toll authority ID | Toll authority which owns the violation transaction |
| Violation Date/Time | Date/Time of the Violation Event |
| Plaza | Plaza code or number |
| Lane | Lane Number |
| Plate Number | Plate Number |
| Plate State | Plate State |
| Plate Type | Plate Type (may be blank) |
| Toll Due | Original Toll Amount |
| Toll Paid | Toll Amount Paid |
| Violation ID | Violation ID from Toll Violation System |
| Workflow ID | Workflow ID from Toll Violation System |
| Image ID | Image ID from Toll Violation System should the |
| | license plate data be found |
| First Disposition | YES = Plate found in Master Plate Table; |
| | NO = Plate not found |
| Final Disposition | YES = License plate data visually confirmed with |
| | image |
| | NO = License plate data did not match image |

In general, the violation transaction (to include exceptions or other types of trigger events referenced vide supra) is passed from the TA to the TPSP for plate lookup.

TPSP 340 receives the violation transaction and looks up 346 the license plate data 366 in the master plate table 242. If the license plate data 366 is found 348 in the master plate table 242, then the violation transaction is saved in the master transaction table 342 for future reference. In various exemplary embodiments, the master transaction table 342 contains an entry for each violation transaction in which the license plate data 366 was found 348 in the master plate table 242. The layout of the master transaction table may comprise any or all of the following:

MASTER TRANSACTION TABLE

| Field | Description |
|---|---|
| TPSP Violation ID | TPSP internal violation ID |
| Toll Authority ID | Toll authority which owns the violation transaction |
| Violation Date/Time | Date/Time of the Violation Event |
| Plaza | Plaza code or number |
| Lane | Lane Number |
| Fleet Company | Hertz, Avis, ABC Limousine Company |
| Plate Number | Plate Number |
| Plate State | Plate State |
| Plate Type | Plate Type (may be blank) |
| Toll Due | |
| Toll Paid | |
| First Disposition | Disposition from automated lookup of license plate |
| | data (will be Yes) |
| First Date/Time | Date/Time the transaction is added to the Master |
| | Transaction Table |
| Final Disposition | Disposition from visual review of image |
| Final Date/Time | Date/Time the transaction is visually reviewed |
| Image ID | Image ID from Toll Violation System should the |
| | license plate data be found |
| Sent Date | Date the transaction is sent to the Fleet Car Agency |
| TPSP Fee | TPSP processing fee changed to the Fleet Toll |
| | Authority |

If license plate data 366 is found 348 in master plate table 346, 242, then the first disposition 350 for the violation transaction is updated to “Yes” and the violation transaction is subsequently passed back to TA 360 for final disposition 372 and reporting. If, however, license plate data 366 is not found in master plate table 346, 242, then the first disposition 350 for the violation transaction is updated to “No” and the violation transaction is passed back to TA 360 for regular violation workflow processing 370.

If the first disposition 350 is “Yes,” then the TA's violation processing system sends the associated data image or back shot image to TPSP 340 for processing (i.e., the returning arrow from element 368 to element 352). TPSP 340 receives and saves the image to database 344, matches it with the appropriate violation transaction and presents the license plate data 366 and the image for manual image review 352. A TPSP 340 image review clerk confirms or rejects 354 that the license plate data matches the image.

If the license plate data 366 matches the image, then the final disposition 356 in the violation transaction is updated to “Yes” and the violation transaction is passed back to TA's violation processing system 372. Additionally, TPSP 340 passes the violation transaction to FVO 326, 320. The violation transaction is passed from TPSP 340 to FVO 326 once the vehicle causing the violation is confirmed as being owned by FVO 326. The layout of the violation transaction transmitted to FVO 326 may be generally defined by the following schema:

VIOLATION TRANSACTION LAYOUT TABLE

| Field | Description |
|---|---|
| Toll Authority | Toll Authority to which the violation transaction is |
| | passed |
| Violation Date/Time | Date/Time of the Violation Event |
| Plaza | Plaza code or number |
| Lane | Lane Number |
| Plate Number | Plate Number |
| Plate State | Plate State |
| Plate Type | Plate Type (may be blank) |
| Toll Due | Original Toll Amount |
| Toll Paid | Toll Amount Paid |
| TPSP Fee | TPSP processing fee changed to the Fleet Toll |
| | Authority |
| Image ID | Image ID from Toll Violation System should the |
| | license plate data be found |

If license plate data 366 does not match the image 352, then the final disposition 356 in the violation transaction is updated to “No” and violation transaction is passed back to TA's violation processing system for normal processing. If the final disposition 356 is “No,” then the violation transaction continues along the normal violation processing workflow. As an option, TA 360 may wish to manually re-review the violation at this point in the workflow since the TPSP 340 manual review was not able to confirm the match between the license plate data 366 and the image 352.

If the final disposition 356 is “Yes,” then TA 360 rejects the violation and counts it as a fleet-based toll, and the toll will be paid 374 by TPSP 340. Verified payment may benefit from a double level of quality assurance performed by TPSP 340, wherein the first quality assurance comprises visual verification of the accuracy of the license plate data 222 provided by FVO 220, and the second quality assurance comprises DMV 250 verification of the accuracy of the license plate data 366 after comparing it to the image 352.

After the TPSP 340 toll collection system passes the violation transaction to FVO 326 with a TPSP 340 processing fee added to the transaction fee, enrollment fee, etc. (taken all together as 324), FVO 326 may collect the tolls from its customer in accordance with the following, for example:

FVO 326 may charge 322 the tolls and convenience fees to the renter's credit card, wherein the total fees charged 322 will generally be more than a standard toll, but a fraction of the actual violation amount; or

Alternatively, FVO 326 could utilize a pre-paid tolls program, which enables FVO 326 to charge renters incremental, pre-paid toll fees, up-front before the vehicle leaves the rental lot.

In the event that a pre-paid charging model is employed, the tolls and fees accumulated by a specific vehicle may be applied to the pre-paid balance when the actual charges are posted. Pre-payment of tolls offers speed and convenience to the renter by allowing the renter to use, for example, high speed toll systems to avoid violation fines, congestion and delay associated with conventional toll collection methods. This can apply to other areas as well, including pre or post paid parking for on-street and garage parking.

In a representative and exemplary embodiment, the pre-paid tolls offering may be similar to standard, existing pre-paid gas products offered by rental car companies. In this case, however, the renter may select a pre-paid amount (e.g., $10.00, $15.00, $20.00, etc.), which, like pre-paid fuel may be pre-paid and applied on a ‘use-it-or-lose-it’ basis. Under this model, FVO 320 may collect and keep the pre-paid tolls revenue and simply apply the tolls and TPSP 340 service fee when it is posted to the account. A credit card can be kept on file (for example, by the FVO 320) to cover toll charges which may be incurred in excess of the pre-paid tolls amount initially collected. A premium may be charged for toll transactions which exceed the pre-paid amounts.

The disclosed fleet-based toll collection system and method may be employed, or otherwise suitably adapted, to enable FVOs 320 and TAs 360 to subscribe to a service which reduces costs while generating new revenue sources without a substantial effort or capital expenditure.

The service could be configured to enable the renter/lessee of the fleet vehicle to dispute the charges through existing TA processes, or the renter/lessee may call the FVO directly. The TPSP processing center can provide online access to the master plate, master transaction and images tables (databases) through, for example, an internet web interface to all subscribed FVOs. The first action item for the TSPS, TA or FVO customer service representative (“CSR”) may be to determine the timeframe and the vehicle that was driven by the caller disputing the charge. Using the license plate data and time frame, the disclosed fleet-based toll collection system may be accessed for the transactions and images associated with the caller. The CSR then reviews the images to ensure that proper identification of the license plate and vehicle were made. If the CSR agrees with the driver that an error was made, the CSR marks the violation for subsequent dispute review.

Disputed transactions may then be automatically queued for TPSP to review the transactions marked for review. Under one scenario, the TPSP and the FVO will arrive at a mutual agreement whether to dismiss the charge or not. In general, the TA will not be required to be involved in the dispute process, and as such, will not incur labor costs and overheads associated with additional disputes.

TPSP may agree with the TAs to pay the tolls to the TAs on a periodic basis. Transactions included with each payment may be determined, for example, by the processing date of the final disposition. Those that fall within the period defined for each payment may be marked as such. The TA may be provided with online access to the disclosed fleet-based toll collection system, for example, to print detail reports of the transactions included with each payment. In addition, web-based online access to review the images associated with each transaction may also be made available.

TPSP may invoice the FVO on an agreed periodic basis for all identified fleet-based tolls and associated TPSP fees. All transactions included with each invoice may be determined by the processing dates of sending the transaction to the FVO. Those that fall within the period defined for each invoice may be marked as such. The FVO may be permitted to have online access to the TPSP fleet-based toll collection system to print detail reports of the transactions included with each invoice. In addition, web-based or other electronic online access to review the images associated with each transaction may also be made available.

Alternatively, for those FVOs that may only be interested in automating the violation administration process, the disclosed fleet-based toll collection system may also be suitably adapted to provide a vehicle identification and renter/lessee tracking feature and violation administration automation service. Accordingly, the disclosed systems and processes described above may be configured to automatically identify rental and fleet vehicles so that violation notices may be issued and mailed directly to the individual renter or lessee, by the TA, without initial manual intervention or processing by the FVO or TA.

Participating FVOs would still provide interfaces and data to the TPSP, which would maintain a current master plate table which may be used to identify rental and fleet vehicles. License plate numbers from violation (as well as exceptions and/or other types of triggering events) images captured in the toll lanes may be processed and compared against the master plate table. If there is a match, TPSP would flag the transaction as “FVO Pending”. The disclosed fleet-based toll collection system may be adapted to perform similar quality assurance processes as described above to confirm accuracy of the license plate number and corresponding vehicle before taking further action.

Thereafter, the TPSP would then query the respective FVO database for the name and address of the vehicle renter or lessee responsible for the vehicle during the time of the violation. Once the renter or lessee information is returned from the FVO database, the information may then be passed to the TA's violation processing system for printing and mailing. Whereas this process may not offer all of the speed and convenience benefits of the pre-paid tolls embodiment described vide supra, it does eliminate costly and time-consuming manual processes associated with conventional rental car violation processing.

Disputes arising from violation notices sent to renters, based on information provided by the renter tracking and violation automation service may be processed in a similar way as any other violation transaction. The service provided by the TPSP will generally not change the process. Rather, it may be regarded as a means to automate existing conventional processes required to identify the vehicle renter.

Additionally, most of the major toll road markets are implementing or planning to implement means to link transponders and transponder accounts to enable cashless payment at airport parking fee collection points. This offers speed and convenience to the user and leverages the installed tag base to remove cash handling from parking revenue transaction processing. In addition to the rental and fleet revenue collection system disclosed herein, the inventors believe that there are a range of Business-to-Consumer applications of the disclosed fleet-based collection of tolls/fines/fees as well. Specifically, various representative and exemplary embodiments of the present invention may be configured, or otherwise suitably adapted, to enable cashless transactions at airports and parking garages, parking facilities and other venues for vehicle based payments, based on, for example, license plate images captured by cameras and/or transponder tags linked to credit card accounts. The quality assurance and back-office processing steps would be similar to what has been described vide supra. One primary difference would be that an individual would potentially register a single or small number of vehicles rather than a large fleet. Additionally, in accordance with an exemplary embodiment, the intermediary TPSP may be configured to keep the credit card information and process the credit card transactions instead of collecting from the registered owner as in the Business-to-Business FVO model.

Databases 144, 146, 148 may be any type of database, such as relational, hierarchical, object-oriented, and/or the like. Representative database products that may be used to implement databases 144, 146, 148 include DB2 by IBM (White Plains, N.Y.), any of the database products available from ORACLE CORPORATION (Redwood Shores, Calif.), MICROSOFT SQL SERVER or ACCESS by MICROSOFT CORPORATION (Redmond, Wash.), Sybase (Dublin, Calif.) or any other database product. The databases may be organized in any manner, including, for example, data tables, look-up tables, matchable data structures or any other method and/or data structure now known or hereafter derived or otherwise described by those skilled in the art.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. Data association may be accomplished by a database merge function, for example, using a key field to generally partition the database according to a class of objects defined by the key field. For example, a certain class may be designated as a key field in both a first data table and a second data table, and the two data tables may then be merged on the basis of the class data in a key field. In an exemplary embodiment, the data corresponding to a key field in each of the merged data tables may be the same; however, data tables having similar, though not identical, data in key fields may also be merged by using AGREP, for example.

Web servers that may be provided to provide FVOs and/or TAs with online access may generally comprises any combination of hardware, software, and/or networking components configured to receive and process requests from client computer(s) and provides a suitable website or other Internet-based user interface which is accessible by client(s). In an exemplary embodiment, the Internet Information Server, MICROSOFT Transaction Server, and MICROSOFT SQL Server, may be used in conjunction with the MICROSOFT operating system, MICROSOFT NT web server software, a MICROSOFT SQL database system, and a MICROSOFT Commerce Server. Additionally, components such as Access, SQL Server, Oracle, MySQL, Sybase, InterBase, and/or the like may be used to provide a compliant database-driven web content management system.

Various representative embodiments of the present invention may be adapted to work with any number of web servers in any permutation of connectivity, such as that of a fail-over or bandwidth acceleration configuration. Skilled artisans will appreciate that numerous optional variants known in the art may be employed for the provision of web access to clients.

Data connections representatively depicted in FIG. 2 and FIG. 3, for example, may comprise any combination of hardware, software and/or other networking components configured to provide communication data paths. A variety of conventional communications media and protocols may be used for data paths such as, for example, an Internet Service Provider (ISP) over the local loop, as is typically used in connection with standard modem communication, a cable modem, a Dish network, an ISDN connection, a Digital Subscriber Line (DSL), various wireless communication methods (e.g., 802.11b/g, BlueTooth, etc.) and/or the like. Device components connected via data paths may also reside within a local area network (LAN) which interfaces to an external network, such as the Internet, via a leased line (T1, T3, etc.). Notwithstanding the preceding, skilled artisans will appreciate that the present invention may be implemented in other network environments as well, including any future alternatives to the Internet, in addition to other suitable inter-networks and/or intra-networks based on other open or proprietary protocols.

Skilled artisans will appreciate that the data connection configurations depicted in the figures are provided for representative and convenient illustration and that many other data connection configurations may be alternatively, conjunctively and/or sequentially employed to produce substantially the same result. The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, data structures, and/or the like, which may carry out a variety of functions under the control of one or more microprocessors or other control devices. Similarly, the software elements of the present invention may be implemented with any programming or scripting language such as, for example, C, C++, Java, COBOL, assembler, PERL, extensible Markup Language (XML), etc., and/or any programming or scripting language now known or hereafter derived or otherwise described in the art, with the various algorithms being implemented with any combination of data structures, objects, processes, routines or other programming elements. Furthermore, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction to cryptography and digital security, please see the text by Bruce Schneider entitled “Applied Cryptography: Protocols, Algorithms, and Source Code In C,” published by John Wiley & Sons (second edition, 1996).

It should be appreciated that the particular implementations shown and described herein are representative of the invention and its best mode and are not intended to limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between various elements. It should be noted that many alternative or additional functional relationships or physical connections may be present in a practical system.

It will be appreciated, that many applications of the present invention may be formulated. One skilled in the art will appreciate that the network may include any system for exchanging data, such as, for example, the Internet, an intranet, an extranet, WAN, LAN, wireless network, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., PALM PILOT, POCKET PC), cellular phone and/or the like. Similarly, the invention could be used in conjunction with any type of personal computer, network computer, workstation, minicomputer, mainframe, and/or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Additionally, the invention may be readily implemented with TCP/IP communications protocols, IPX, Appletalk, IP-6, NetBIOS, OSI or any number of existing or future standards or protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the Internet. In this context, the computers may or may not be connected to the Internet at all times.

As will be appreciated by skilled artisans, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or the like.

Data communication may be accomplished through any suitable communication means, such as, for example, a telephone network, Intranet, Internet, point of interaction device (POS device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system component optionally includes any of various suitable security features, such as firewalls, access codes, encryption, de-encryption, compression, decompression, and/or the like.

The present invention is described herein with reference to block diagrams, devices, aggregated systems and computer program products according to various aspects of the invention. It will be understood that each functional block of the block diagrams, and combinations of functional blocks in the block diagrams, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block diagrams.

These computer program instructions may also be stored in a computer-readable memory that can direct a computer or other programmable data processing device to function in a particular manner, such that the instructions stored in the computer-readable memory produce an article of manufacture including instruction means which implement the functions specified in the block diagrams. The computer program instructions may also be loaded onto a computer or other programmable data processing device to cause a series of operational steps to be performed on the computer or other programmable apparatus to produce a computer-implemented process such that the instructions which execute on the computer or other programmable apparatus provide steps for implementing the functions specified in the block diagrams.

Accordingly, the block diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams, can be implemented by either special purpose hardware-based computer systems which perform the specified functions or steps, or suitable combinations of special purpose hardware and computer instructions.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. A method for processing a toll transaction, said method comprising the steps of:
a toll processing service provider providing a vehicle information database;
a toll authority providing toll transaction data to said toll processing service provider;
a fleet vehicle owner providing fleet vehicle information to said toll processing service provider;
said toll authority providing at least one of graphical and textual data corresponding to a fleet vehicle associated with said toll transaction;
said toll processing service provider comparing at least one of said graphical data and textual data with said fleet vehicle information, wherein a match between the data provided by said toll authority and the fleet vehicle information provided by the fleet vehicle owner results in at least one of: a fee charged to said fleet vehicle owner by said toll processing service provider; a fee charged to the operator of said fleet vehicle by said toll processing service provider; and a payment made to said toll authority by said toll processing service provider.

2. The method of claim 1, wherein at least one of:
said toll transaction information comprises at least one of a violation, an exception and a triggering event;
said toll comprises at least one of a road-use fee, a bridge-use fee, a tunnel-use fee, a ferry fee, a parking fee, a parking fine, and a traffic fine; and
said toll processing service provider comprises the toll authority.

3. The method of claim 1, wherein at least one of:
said graphical data comprises an image comprising said vehicle's license plate; and
said textual data comprises at least one of said vehicle's license plate text and an alphanumeric identification string corresponding to said vehicle.

4. The method of claim 3, wherein at least one of:
said alphanumeric identification string is obtained from at least one of a transponder, an RFID device, and a wireless electronic communication device; and
said identification string is obtained from a barcode.

5. The method of claim 1, wherein said fee comprises at least one of a toll fee, a transaction fee, a processing fee and an enrollment fee.

6. The method of claim 1, further comprising the step of said fleet owner charging a second fee to at least one of an operator, a renter, and a lessee of said fleet vehicle responsible for said toll transaction; and
said second fee comprises at least one of a toll fee, a transaction fee, a processing fee and an enrollment fee.

7. The method of claim 1, further comprising the step of said fleet owner charging a pre-paid fee to the operator of said fleet vehicle, said pre-paid fee corresponding to at least one of future toll transactions and fees that the vehicle may incur.

8. The method of claim 7, wherein said pre-paid fee comprises at least one of a toll fee, a transaction fee, a processing fee and an enrollment fee.

9. The method of claim 1, further comprising the step of said fleet vehicle owner providing information corresponding to a plurality of fleet vehicles.

10. The method of claim 9, wherein said fleet vehicle information comprises at least one of a database, xml, and relational file type.

11. The method of claim 1, further comprising the step of said toll processing service provider comparing said fleet vehicle information with at least one of Department of Motor Vehicle records, vehicle registration records, and vehicle ownership records.

12. The method of claim 11, further comprising the step of reviewing said records to verify that said fleet vehicle owner is registered with the Department of Motor Vehicles as the owner of said fleet vehicle.

13. The method of claim 12, further comprising the step of said toll processing service provider at least one of:
enrolling at least one of an individual and a fleet vehicle information into said vehicle information database if said fleet vehicle is determined to be registered to said fleet vehicle owner; and
rejecting fleet vehicle information from enrollment into said vehicle information database if said fleet vehicle is determined not to be registered to said fleet vehicle owner.

14. The method of claim 1, further comprising the step of said toll processing service provider providing a toll transaction database.

15. A system for processing a toll transaction, said system comprising:
a toll processing service provider, said service provider suitably adapted to provide a vehicle information database;
a toll authority, said toll authority suitably adapted to provide toll transaction data to said toll processing service provider;
a fleet vehicle owner, said fleet vehicle owner suitably adapted to provide fleet vehicle information to said toll processing service provider;
said toll authority further suitably adapted to provide at least one of graphical and textual data corresponding to a fleet vehicle associated with said toll transaction;
said toll processing service provider suitably adapted to compare at least one of said toll transaction data, graphical data and textual data with said fleet vehicle information;
said toll processing service provider further suitably adapted for performing said toll transaction by charging a fee to said fleet vehicle owner and making a payment to said toll authority.

16. The system of claim 15, wherein at least one of:
said toll transaction information comprises at least one of a toll violation, an exception, and a triggering event; and
said toll processing service provider comprises the toll authority.

17. The system of claim 15, wherein at least one of:
said graphical data comprises an image of said vehicle's license plate; and
said textual data comprises at least one of said vehicle's license plate text and an alphanumeric identification string corresponding to said vehicle.

18. The system of claim 15, wherein said fee comprises at least one of a toll fee, a transaction fee, a processing fee and an enrollment fee.

19. A method for identifying a vehicle for subsequent processing of a toll transaction, said method comprising the step of a fleet vehicle owner providing fleet vehicle information to a toll processing service provider, where the service provider is suitably configured to compare the fleet vehicle information with at least one of graphical data and textual data provided by a toll authority.

20. The method of claim 19, wherein said toll processing service provider comprises said toll authority.

21. A method for fleet-based processing of a plurality of toll transactions, said method comprising the steps of:
a toll processing service provider providing a vehicle information datastore;
a plurality of toll agencies providing toll transaction data to said toll processing service provider;
a plurality of fleet vehicle owners providing fleet vehicle information to said toll processing service provider;
said toll agencies providing at least one of graphical and textual data corresponding to at least one fleet vehicle associated with said plurality of toll transactions;
said toll processing service provider comparing at least one of said graphical data and textual data with said fleet vehicle information, wherein a match between the data provided by said toll authority and the fleet vehicle information provided by the fleet vehicle owner results in at least one of: a fee charged to at least one of said fleet vehicle owner by said toll processing service provider; a fee charged to at least one operator of said at least one fleet vehicle; and a payment made to at least one of said toll agencies by said toll processing service provider.

22. The method of claim 21, wherein at least one of said fee charged to said at least one fleet vehicle owner and said fee charged to said at least one operator of said at least one fleet vehicle comprises an aggregation of at least a plurality of said fees.

23. The method of claim 21, wherein said payment made to at least one of said toll agencies by said toll processing service provider comprises an aggregation of at least a plurality of said payments.

24. A method for the payment of toll transactions, said method comprising the steps of:
a toll processing service provider providing a vehicle information datastore;
a toll authority providing toll transaction data to said toll processing service provider;
a fleet vehicle owner providing fleet vehicle information to said toll processing service provider;
a fleet vehicle operator purchasing a predetermined toll fee credit from at least one of said fleet vehicle operator and toll processing service provider;
said toll authority providing at least one of graphical and textual data corresponding to a fleet vehicle associated with said toll transaction;
said toll processing service provider comparing at least one of said graphical data and textual data with said fleet vehicle information, wherein a match between the data provided by said toll authority and the fleet vehicle information provided by the fleet vehicle owner results in at least one of: a fee charged to said fleet vehicle owner by said toll processing service provider; and a payment made to said toll authority by said toll processing service provider.

25. The method of claim 24, further comprising the steps of:
at least one of said toll processing service provider and said fleet vehicle owner determining whether said fleet vehicle operator has exceeded said toll fee credit; and
at least one of said toll processing service provider and said fleet vehicle owner charging an additional fee to said fleet vehicle operator.

26. The method of claim 25, wherein said additional fee comprises at least one of a toll fee, a transaction fee, a processing fee, an enrollment fee and an overage fine.
